(19) United States
(12) Patent Application Publication
(10) Pub. No.: US 2018/0002505 A1
(43) Pub. Date: Jan. 4, 2018

(54) POLYPROPYLENE RESIN COMPOSITION WITH IMPROVED FOAMING CAPABILITY

(71) Applicants: Hyundai Motor Company, Seoul (KR); LOTTE CHEMICAL CORPORATION, Seoul (KR)

(72) Inventors: Boo-Youn AN, Seoul (KR); Dae-Sik KIM, Yongin-si (KR); In-Soo HAN, Uiwang-si (KR); Kyeong-Hoon JANG, Seoul (KR); Seul YI, Seoul (KR); Seong-Min JO, Daejeon (KR); Eun-Hwa JANG, Daejeon (KR); Yeong-Beom KIM, Daejeon (KR)

(73) Assignees: Hyundai Motor Company, Seoul (KR); LOTTE CHEMICAL CORPORATION, Seoul (KR)

(21) Appl. No.: 15/364,769

(22) Filed: Nov. 30, 2016

(30) Foreign Application Priority Data
Jul. 4, 2016 (KR) 10-2016-0084382

(51) Int. Cl. C08J 9/00; C08J 9/06

(52) U.S. Cl. CPC C08J 9/0085; C08J 9/06; C08J 2323/12

(57) ABSTRACT

Provided herein is a composition of a polypropylene resin with improved foaming capability with improved foaming capability, such as a polypropylene comprising a foaming agent master batch and a highly flowable polypropylene resin having non-controlled rheology. The resin composition exhibits excellent foaming quality and can be easily injected.

The polypropylene resin with improved foaming capability comprises a mixture comprising from about 50% to about 80% by weight of a polypropylene resin having a mean molecular weight of about 45,000 g/mol to about 180,000 g/mol, from about 15% to about 30% by weight of a fiber reinforcing agent, and from about 2% to about 20% by weight of a foaming agent.

### CROSS-REFERENCE TO RELATED APPLICATION

This application claims under U.S.C. §119(a) the benefit of Korean Patent Application No. 10-2016-0084382, filed on July 4, the contents of which are herein incorporated by reference for all purposes.

### BACKGROUND OF THE INVENTION

### Field of the Invention

The present invention relates to a polypropylene resin composition with improved foaming capability. Exemplary embodiments of the polypropylene resin composition with improved foaming capability includes a foaming agent master batch and a highly flowable polypropylene resin having uncontrolled rheology, and thereby exhibits excellent foaming quality and is easily injectable.

### Description of the Related Art

In response to increasing environmental problems over the world, fuel savings solutions are being developed in all industries. Solutions to fuel savings suggested by the automobile industry are to improve fuel efficiency of automobile engines and to reduce automobile weight. Reducing automobile weight is a good solution to improving fuel economy. However, reducing automobile weight can cause problems with insufficient strength and durability needed for automobiles. Accordingly, an important objective of the automobile industry is to overcome this problem.

Thus, a variety of eco-friendly automobiles are under development in the automobile industry to decrease a carbon dioxide exhaust to 95 g/km, which corresponds to a 27% reduction of the current carbon dioxide exhaust by 2021, based on the European Regulation standards. In addition, automobile makers are developing technologies for downsizing the automobiles and increasing fuel economy in order to meet the 54.5 mpg (23.2 km/l) standard regulated by the US Corporate Average Fuel Economy (CAFE), by 2025.

As the demand for weight reduction in the automobile and electronic industries increases, there remains a need for foaming resin compositions having a low specific gravity. In order to commercialize a foaming resin having a low specific gravity, necessary levels of mechanical strength and processability should be maintained. However, the rigidity of known resin compositions rapid decrease after foaming. As such, maintaining rigidity of the resin after foaming is an important property for foaming materials with a low specific gravity.

Accordingly, the present invention has been made in view of the above problems of the prior art and the present invention provides a polypropylene resin with improved foaming capability.

### SUMMARY OF THE INVENTION

The present invention has been made in view of the above problems and to provide a polypropylene resin composition with improved foaming capability. Exemplary embodiments of the resin composition include a foaming agent master batch and a highly flowable polypropylene resin having uncontrolled rheology. Such a resin composition exhibits excellent foaming quality and can be easily injected.

The present invention also provides an automobile interior or exterior part comprising a polypropylene resin composition disclosed herein that has an improved foaming capability that can reduce automobile weight and improve fuel economy.

The objects of the present invention are not limited to those described above and other objects not stated herein may be clearly understood by those skilled in the art from the following description.

In accordance with the present invention, the above and other objects can be accomplished by the provision of a polypropylene resin with improved foaming capability comprising a mixture comprising (a) from about 50% to about 80% by weight of a polypropylene resin having a mean molecular weight of from about 45,000 g/mol to about 180,000 g/mol, (b) from about 15% to about 30% by weight of a fiber reinforcing agent, and (3) from about 2% to about 20% by weight of a foaming agent.

Exemplary embodiments of the polypropylene resin may include from about 45 to about 65 (e.g., about 45, 50, 55, 60 or about 65) parts by weight a propylene homopolymer having a molecular weight distribution of from about 5 to about 12 (e.g., about 5, 6, 7, 8, 9, 10, 11, or about 12), with respect to 100 parts by weight of the polypropylene resin.

The polypropylene resin of the present invention may be a highly flowable polypropylene resin having uncontrolled rheology.

Exemplary embodiments of the polypropylene resin may include one or more selected from the group consisting of: a random polymer polymerized from a co-monomer selected from the group consisting homo-polypropylene propylene, ethylene, butylene and octane; a block copolymer including a blend of polypropylene and an ethylene-propylene rubber; and a copolymer of polyethylene, ethylene vinyl acetate and α-olefin.

Exemplary embodiments of the fiber reinforcing agent of the present invention may have a length of from about 5 mm to about 20 mm (e.g., about 5, 6, 7, 8, 9, 10, 11, 12, 13, 14, 15, 16, 17, 18, 19, or about 20 mm).

The fiber reinforcing agent may include one or more of the following: talc, calcium carbonate, calcium sulfate, magnesium oxide, calcium stearate, wollastonite, mica, silica, calcium silicate, nano-clay, whiskers, glass fibers, carbon fibers, carbon black and a mixture thereof.

Preferably, the foaming agent is a master batch.

Preferably, the foaming agent is a thermally expandable microcapsule.

Preferably, the foaming agent includes azodicarbonamide, sodium bicarbonate, zinc di-benzenesulfinate, zinc di-toluene sulfinate, p-toluene sulfonyl hydrazide, benzene sulfonyl hydrazide or a mixture thereof.

Exemplary embodiments of the polypropylene resin with improved foaming capability may further comprise two or more additives selected from the group consisting of an impact modifier, an inorganic filler, an antioxidant, a lubricant, an antistatic agent, a compatibilizer and a fine particle.

In another aspect of the present invention, provided herein is an automobile interior or exterior part comprising the polypropylene resin with improved foaming capability provided herein.

### BRIEF DESCRIPTION OF THE DRAWINGS

The above and other objects, features and other advantages of the present invention will be more clearly understood from the following detailed description taken in conjunction with the accompanying drawings, in which:

The above and other objects, features and other advantages of the present invention will be more clearly understood from the following detailed description taken in conjunction with the accompanying drawings, in which:

FIG. 1 is an image showing an automobile C/pad core part comprising or consisting of a polypropylene resin with improved foaming capability according to embodiments of the present invention.

FIG. 2 is a cross-sectional enlarged image taken along the line A-A′ of the automobile C/pad core part comprising or consisting of a polypropylene resin with improved foaming capability according to embodiments of the present invention.

### DETAILED DESCRIPTION OF THE INVENTION

Hereinafter, preferred embodiments of the present invention will be described in detail with reference to the annexed drawings. In addition, the terms and words used in the present specification and claims should not be construed to be limited to the common or dictionary meaning, because an inventor can define the concept of the terms appropriately to describe his/her invention in the best manner. Therefore, they should be construed as a meaning and concept fit to the technological concept and scope of the present invention. Accordingly, configurations described in the specification and drawings are provided as the most preferred embodiments of the present invention and do not represent all of the technical ideas of the present invention. Thus, it should be understood that there are a variety of equivalents and modifications to these configurations at a time of filing.

The present invention relates to a polypropylene resin with improved foaming capability.

More specifically, the present invention provides a polypropylene resin composition with improved foaming capability containing a mixture of from about 50% to about 80% (e.g., about 50%, 55%, 60%, 65%, 70%, 75%, or about 80%) by weight of a polypropylene resin having a mean molecular weight of from about 45,000 g/mol to about 180,000 g/mol (e.g., about 45,000; 50,000; 60,000; 70,000; 80,000; 90,000; 100,000; 110,000; 120,000; 130,000; 140,000; 150,000; 160,000; 170,000 or about 180,000 g/mol); from about 15% to about 30% (e.g., about 15%, 16%, 17%, 18%, 19%, 20%, 21%, 22%, 23%, 24%, 25%, 26%, 27%, 28%, 29%, or about 30%) by weight of a fiber reinforcing agent; and from about 2% to about 20% (e.g., about 2%, 3%, 4%, 5%, 6%, 7%, 8%, 9%, 10%, 11%, 12%, 13%, 14%, 15%, 16%, 17%, 18%, 19% or about 20%) by weight of a foaming agent. In exemplary embodiments of the present invention, the polypropylene resin contains from about 45 to about 65 (e.g., about 45, 46, 47, 48, 49, 50, 51, 52, 53, 54, 55, 56, 57, 58, 59, 60, 61, 62, 63, 64, or about 65) parts by weight of a propylene homopolymer having a molecular weight distribution of from about 5 to about 12 (e.g., about 5, 6, 7, 8, 9, 10, 11, or about 12), with respect to 100 parts by weight of the polypropylene resin, and the polypropylene resin is preferably a highly flowable polypropylene resin having uncontrolled rheology. The polypropylene resin also preferably includes one or more selected from the group consisting of: a random polymer polymerized from a co-monomer selected from the group consisting of a homo-polypropylene propylene, ethylene, butylene and octane; a block copolymer including a blend of polypropylene with an ethylene-propylene rubber; and a copolymer of polyethylene, ethylene vinyl acetate and α-olefin, and the fiber reinforcing agent preferably having a length of from about 5 mm to about 20 mm (e.g., about 5, 6, 7, 8, 9, 10, 11, 12, 13, 14, 15, 16, 17, 18, 19 or about 20 mm). Furthermore, the fiber reinforcing agent can also include one or more of the following: talc, calcium carbonate, calcium sulfate, magnesium oxide, calcium stearate, wollastonite, mica, silica, calcium silicate, nano-clay, whiskers, glass fibers, carbon fibers, carbon black and a mixture thereof, and a foaming agent, preferably the foaming agent is a master batch. Exemplary embodiments of the foaming agent of the present invention is a thermally expandable microcapsule. The foaming agent preferably includes azodicarbonamide, sodium bicarbonate, zinc di-benzene sulfinate, zinc di-toluene sulfinate, p-toluene sulfonyl hydrazide, benzene sulfonyl hydrazide or a mixture thereof. In some embodiments, the polypropylene resin further includes two or more additives comprising an impact modifier, an inorganic filler, an antioxidant, a lubricant, an antistatic agent, a compatibilizer and a fine particle.

More specifically, the present invention provides a material which exhibits excellent foaming qualities, surface qualities and impact resistance. Provided herein is a polypropylene resin composition comprising a foaming agent master batch for foaming injection molding. In addition, an object of the present invention is to prepare a polypropylene resin composition containing a chemical foaming agent or capsule foaming agent master batch and to provide an automobile interior and exterior part produced therefrom.

In the present invention, the polypropylene resin preferably includes a propylene homopolymer having a molecular weight distribution of from about 5 to about 12 (e.g., about 5, 6, 7, 8, 9, 10, 11, or about 12). The molecular weight distribution of the propylene homopolymer means a distribution of molecular weight in the polymer and is commonly a ratio of a weight average molecular weight and a number average molecular weight. As the ratio reaches 1, distribution becomes narrow. When the molecular weight distribution of the propylene homopolymer is 5 to 12, the problem of deterioration in bonding force between the polypropylene resin composition and the fiber reinforcing agent can be solved.

Exemplary embodiments of the polypropylene resin is a highly flowable polypropylene resin having non-controlled rheology (non C.R). In general, a highly flowable polypropylene resin having controlled rheology (C.R) decreases the molecular weight of an additive (peroxide) used for rheological control (flowability control). Accordingly, poor physical properties are due to the relatively low molecular weight content and decreased foaming property is due to low melt tension. On the other hand, the non C.R polypropylene resin has excellent physical properties due to a high molecular weight and an improved foaming property due to a high melt tension. Enhanced flowability improves as the molecular weight distribution and processability increases. Accordingly, known polypropylene resins use C.R to improve impregnation of the fiber reinforcing agent, but problems of low melt tension and relatively low foaming property arise due to narrow molecular weight distribution. The polypropylene resin composition of the present invention is characterized by improved impregnation between the fiber reinforcing agent and the polypropylene resin, increased melt tension, and improved foaming property by using a highly flowable polypropylene resin with non-controlled rheology (non C.R).

In the present invention, the propylene homopolymer is preferably present in an amount of from about 45 to about 65 (e.g, about 45, 50, 55, 60 or about 65) parts by weight, with respect to 100 parts by weight of the polypropylene resin. When the propylene homopolymer is less than about 45 parts by weight, moldability is disadvantageously lowered. When the propylene homopolymer is present in an amount exceeding about 65 parts by weight, mechanical property, such as impact strength is disadvantageously decreased in products made of the polypropylene resin.

In exemplary embodiments of the present invention, the fiber reinforcing agent is preferably from about 5 mm to about 20 mm (e.g., about 5, 6, 7, 8, 9, 10, 11, 12, 13, 14, 15, 16, 17, 18, 19 or about 20 mm). When the length of the fiber reinforcing agent is less than about 5 mm, mechanical properties of the polypropylene resin disadvantageously deteriorate. When the length of the fiber reinforcing agent exceeds about 20 mm, it is disadvantageously difficult to feed raw materials into an injection machine due to deteriorated production efficiency and impregnation efficiency of the polypropylene resin. The fiber reinforcing agent can be preferably present in an amount of from about 15% to about 30% (e.g., about 15%, 16%. 17%, 18%, 19%, 20%, 21%, 22%, 23%, 24%, 25%, 26%, 27%, 28%, 29% or about 30%) by weight. The fiber reinforcing agent is an ingredient to improve dispersibility of the foaming agent and prevent mutual interruption. Such a fiber reinforcing agent can be used without any limitation. Preferably, the fiber reinforcing agent comprises talc, calcium carbonate, calcium sulfate, magnesium oxide, calcium stearate, wollastonite, mica, silica, calcium silicate, nano-clay, whiskers, glass fibers, carbon fibers, carbon black or a mixture thereof.

In exemplary embodiments of the present invention, the foaming agent is preferably a master batch or a thermally expandable microcapsule. The foaming agent preferably includes azodicarbonamide, sodium bicarbonate, zinc di-benzene sulfinate, zinc di-toluene sulfinate, p-toluene sulfonyl hydrazide, benzene sulfonyl hydrazide or a mixture thereof and the foaming agent is preferably present in an amount of from about 2% to 20% (e.g., about 2%, 3%, 4%, 5%, 6%, 7%, 8%, 9%, 10%, 11%, 12%, 13%, 14%, 15%, 16%, 17%, 18%, 19%, or about 20%) by weight. When the foaming agent is present in an amount of less than about 2% by weight, foaming capability deteriorates and weight reduction is insufficient due to excessively low foaming agent content. When the foaming agent is present in an amount of exceeding about 20% by weight, problems of foaming nucleation occur during the production of products made of the polypropylene resin composition. Also, mechanical properties can deteriorate due to the excessively high amount of foaming agent with a low specific gravity.

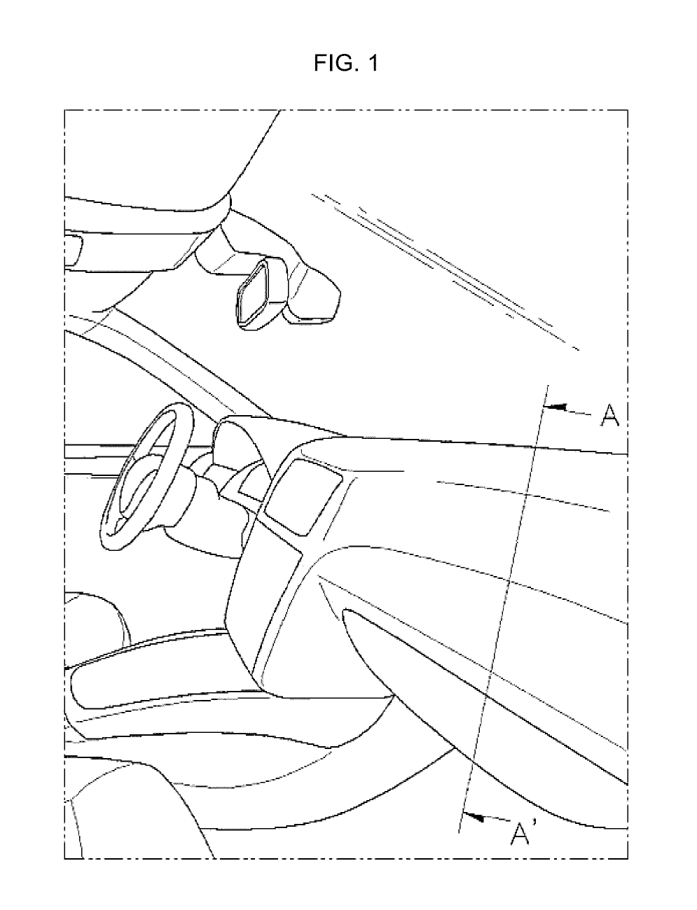

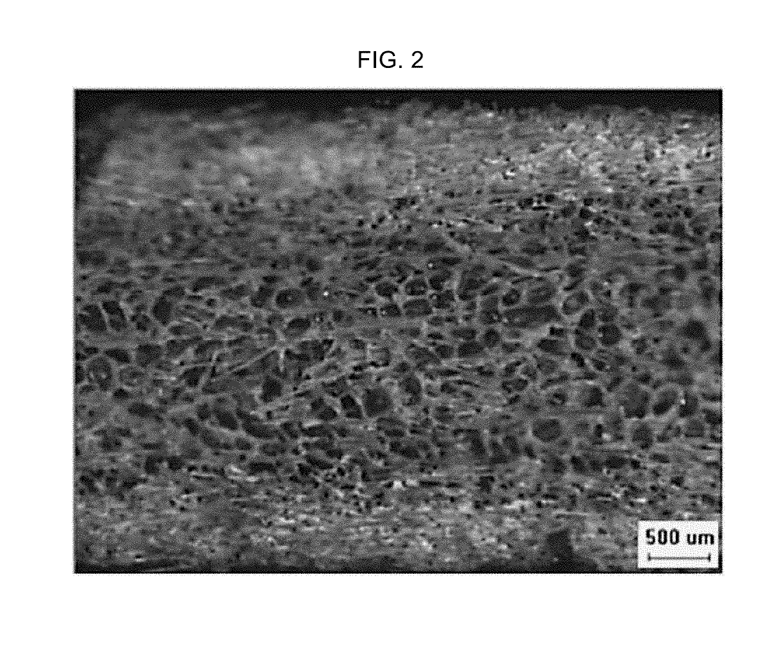

In another aspect of the present invention, provided herein is an automobile interior or exterior part comprising the polypropylene resin with improved foaming capability outlined above. FIG. 1 is an image showing an automobile C/pad core part including a polypropylene resin with improved foaming capability according to an embodiment of the present invention. FIG. 2 is an enlarged cross-sectional image taken along the line A-A′ of the automobile C/pad core part including an exemplary polypropylene resin with improved foaming capability of the present invention. In automobile C/pad core part as shown in FIG. 1, weight reduction is reflected in the large amount of foaming cells within the part, as shown in FIG. 2.

### Example

Hereinafter, the present invention will be described in more detail with reference to the following examples, and it will be obvious to those skilled in the art that these examples are provided only for illustration of the present invention and the scope of the present invention is not limited thereto.

TABLE 1

| | Comparative | Comparative | Comparative | Comparative | |
|---|---|---|---|---|---|
| Items | Example 1 | Example 2 | Example 3 | Example 4 | Example 1 |
| B-PP A | — | — | — | 62 | — |
| (% by weight) | | | | | |
| B-PP B | 80 | 62 | 62 | — | 62 |
| (% by weight) | | | | | |
| Glass fiber A | — | — | — | 20 | 20 |
| (% by weight) | | | | | |
| Glass fiber B | — | — | 20 | — | — |
| (% by weight) | | | | | |
| Talc | 20 | 20 | — | — | — |
| (% by weight) | | | | | |
| Impact modifier | — | 10 | 18 | 18 | 18 |
| rubber | | | | | |
| (% by weight) | | | | | |
| Sodium | — | 3 | 3 | 3 | 3 |
| carbonate | | | | | |
| (% by weight) | | | | | |

Table 1 shows ingredients present in Comparative Examples 1 to 4 according to the prior art and Example 1 according to the present invention. The B-PP A of Table 1 is a C.R highly flowable polypropylene resin (melt index: 30 g/10 min, available from Lotte Chemical Corp.) which corresponds to a basic resin required to produce a composite material. In addition, B-PP B is a non C.R highly flowable polypropylene resin (melt index: 30 g/10 min, available from Lotte Chemical Corp.) which corresponds to a basic resin required to produce a composite material. Furthermore, the glass fiber A is a fiber reinforcing agent which has across-sectional diameter of 15 μm and a length of 11 mm (available from Owens Corning Corp.) In addition, glass fiber B is a fiber reinforcing agent which has across-sectional diameter of 15 μm and a length of 4 mm (available from Owens Corning Corp.). Furthermore, talc is a fiber reinforcing agent which has a cross-sectional diameter of 5.5 μm (available from coats & Clark Inc.). In addition, the impact modifier, rubber has a MI of 12 g/10 min and a weight average molecular weight of 105,000 g/mol (available from Dow Chemical Company). Additionally, the foaming agent is sodium carbonate (available from EIWA Co., Ltd.). The melting index (MI) was measured at 230° C. and a load of 2.16 kg in accordance with ASTM D1238.

Comparative Example 1 was conducted in the same manner as in Example 1, for comparative evaluation with Example 1, except that the foaming agent and the impact modifier were not used and the fiber reinforcing agent was different. In Comparative Example 2, a specimen was formed in the same manner as in Example 1, for comparative evaluation with Example 1, except that a fiber reinforcing agent was different. In Comparative Example 3, a specimen was formed in the same manner as in Example 1, for comparative evaluation with Example 1, except that the length of the fiber reinforcing agent was changed. In Comparative Example 4, a specimen was formed in the same manner as in Example 1, for comparative evaluation with Example 1, except that the basic resin (C.R flowable polypropylene resin) was changed.

Mechanical properties were measured in accordance with ingredients of Comparative Examples 1 to 4 according to the prior art and Example 1 according to the present invention. The following Table 2 shows physical properties of Comparative Examples 1 to 4 according to the prior art and Example 1 according to the present invention.

TABLE 2

| | Comparative | Comparative | Comparative | Comparative | |
|---|---|---|---|---|---|
| Items | Example 1 | Example 2 | Example 3 | Example 4 | Example 1 |
| Specific gravity | 1.07 | 1.04 | 1.01 | 1.01 | 1.01 |
| Tensile strength (MPa) | 26 | 17 | 37 | 45 | 51 |
| Flexural strength (MPa) | 35 | 23 | 42 | 58 | 63 |
| Flexural modulus (MPa) | 2,380 | 2,016 | 2,435 | 2,750 | 2,917 |
| Impact strength | 65 | 115 | 225 | 275 | 327 |
| (@23° C.)(J/m) | | | | | |

Tensile strength of Table 2 was measured from a specimen produced in accordance with ASTM D638. In addition, the flexural modulus was measured from a specimen produced in accordance with ASTM D790. Furthermore, the impact strength was measured from a specimen produced in accordance with ASTM D256. Furthermore, the specific gravity was measured in accordance with ASTM D792.

TABLE 3

| | Automobile C/pad | Automobile C/pad core part |
|---|---|---|
| | core part according | according to Example 1 of |
| Items | to the prior art | the present invention |
| Thickness (mm) | 3.5 | 3.5 |
| Weight of product (g) | 1636 | 1309 |
| Weight reduction (%) | Standard | 20 |

Table 3 shows comparison of thickness, weight of product and weight reduction between an automobile C/pad core part according to the prior art and an automobile C/pad core part according to Example 1 of the present invention. The automobile C/pad core part of the prior art has a thickness of 3.5 mm and a weight of 1636 g, whereas the automobile C/pad core part according to Example 1 of the present invention has the same thickness and a weight of 1309 g which corresponds to a 20% weight reduction of the prior art. In addition, as can be seen from FIG. 2, foam cells are uniformly formed on the cross-sectional surface of the automobile C/pad core part, which illustrates that the weight is reduced as compared to the prior art.

The polypropylene resin with improved foaming capability according to the present invention includes a foaming agent master batch and a highly flowable polypropylene resin having non-controlled rheology, thereby advantageously exhibiting improved processability, low specific gravity and excellent mechanical properties such as high impact strength and uniform weight and composition. In addition, the fiber reinforcing agent can eliminate deterioration in rigidity after foaming as is seen in known foaming materials. As such, the polypropylene resin composition of the present invention provides weight reduction when used in various automobile parts.

Exemplary embodiments of the polypropylene resin with improved foaming capability have excellent foaming qualities and can be easily injected.

In addition, automobile interior parts composed of the resin compositions outlined herein can reduce the weight of the automobile and increase fuel economy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A polypropylene resin with improved foaming capability comprising a mixture comprising:
from 50% to 80% by weight of a polypropylene resin having a mean molecular weight of from 45,000 g/mol to 180,000 g/mol;
from 15% to 30% by weight of a fiber reinforcing agent; and
from 2% to 20% by weight of a foaming agent.

2. The polypropylene resin with improved foaming capability according to claim 1, wherein the polypropylene resin comprises from 45 to 65 parts by weight of a propylene homopolymer having a molecular weight distribution of from 5 to 12, with respect to 100 parts by weight of the polypropylene resin.

3. The polypropylene resin with improved foaming capability according to claim 1, wherein the polypropylene resin is a highly flowable polypropylene resin having non-controlled rheology.

4. The polypropylene resin with improved foaming capability according to claim 1, wherein the polypropylene resin comprises one or more selected from the group consisting of: a random polymer polymerized from a comonomer selected from the group consisting of a homo-polypropylene propylene, ethylene, butylene and octane; a block copolymer comprising a blend of polypropylene and an ethylene-propylene rubber; and a copolymer of polyethylene, ethylene vinyl acetate and α-olefin.

5. The polypropylene resin with improved foaming capability according to claim 1, wherein the fiber reinforcing agent has a length of from 5 mm to 20 mm.

6. The polypropylene resin with improved foaming capability according to claim 1, wherein the fiber reinforcing agent comprises one or more selected from the group consisting of talc, calcium carbonate, calcium sulfate, magnesium oxide, calcium stearate, wollastonite, mica, silica, calcium silicate, nano-clay, whiskers, glass fibers, carbon fibers, carbon black and a mixture thereof.

7. The polypropylene resin with improved foaming capability according to claim 1, wherein the foaming agent is a master batch.

8. The polypropylene resin with improved foaming capability according to claim 1, wherein the foaming agent is a thermally expandable microcapsule.

9. The polypropylene resin with improved foaming capability according to claim 1, wherein the foaming agent comprises azodicarbonamide, sodium bicarbonate, zinc di-benzene sulfinate, zinc di-toluene sulfinate, p-toluene sulfonyl hydrazide, benzene sulfonyl hydrazide or a mixture thereof.

10. The polypropylene resin with improved foaming capability according to claim 1, further comprising two or more additives selected from the group consisting of an impact modifier, an inorganic filler, an antioxidant, a lubricant, an antistatic agent, a compatibilizer and a fine particle.

11. An automobile interior or exterior part comprising the polypropylene resin with improved foaming capability according to claim 1.

12. An automobile interior or exterior part comprising the polypropylene resin with improved foaming capability according to claim 2.

13. An automobile interior or exterior part comprising the polypropylene resin with improved foaming capability according to claim 3.

14. An automobile interior or exterior part comprising the polypropylene resin with improved foaming capability according to claim 4.

15. An automobile interior or exterior part comprising the polypropylene resin with improved foaming capability according to claim 5.

16. An automobile interior or exterior part comprising the polypropylene resin with improved foaming capability according to claim 6.

17. An automobile interior or exterior part comprising the polypropylene resin with improved foaming capability according to claim 7.

18. An automobile interior or exterior part comprising the polypropylene resin with improved foaming capability according to claim 8.

19. An automobile interior or exterior part comprising the polypropylene resin with improved foaming capability according to claim 9.

20. An automobile interior or exterior part comprising the polypropylene resin with improved foaming capability according to claim 10.
